(19) United States
(12) Patent Application Publication
(10) Pub. No.: US 2025/0364901 A1
(43) Pub. Date: Nov. 27, 2025

(54) RECTIFIER CIRCUIT

(71) Applicant: ROHM CO., LTD., Kyoto-shi (JP)

(72) Inventors: Shuichiro MOTOORI, Kyoto-shi (JP); Akihiro KAWANO, Kyoto-shi (JP); Toshiyuki ZAITSU, Kyoto-shi (JP)

(21) Appl. No.: 19/219,041

(22) Filed: May 27, 2025

(30) Foreign Application Priority Data
May 27, 2024 (JP) 2024-085804

(51) Int. Cl. H02M 1/14; H02M 1/00; H02M 3/335; H02M 7/06

(52) U.S. Cl. CPC H02M 1/14; H02M 1/007; H02M 3/33571; H02M 7/06

(57) ABSTRACT

In a rectifier circuit, a bridge circuit rectifies an AC voltage. A voltage clamp circuit includes a clamp transistor, and a smoothing capacitor sequentially connected in series between an output terminal of the bridge circuit and a ground line, and controls on and off of the clamp transistor according to an output voltage of the bridge circuit. A DC/DC converter at a subsequent stage is connected in parallel with the smoothing capacitor.

### CROSS REFERENCE TO RELATED APPLICATIONS

The present invention claims priority under 35 U.S.C. § 119 to Japanese Application No. 2024-085804, filed on May 27, 2024, the entire contents of which being incorporated herein by reference.

### BACKGROUND

### 1. Technical Field

The present disclosure relates to a rectifier circuit and an AC/DC converter.

### 2. Description of the Related Art

An AC (Alternating Current)/DC (Direct Current) converter is used to supply power from a commercial AC power supply to an electronic device. The AC/DC converter includes a rectifier circuit that rectifies an AC voltage, and a DC/DC converter that converts an output voltage of the rectifier circuit into a voltage level suitable for a load.

In AC/DC converters of 75 W or less that do not require power factor correction (PFC), it is general to use an AC rectifier circuit in which a diode bridge and an electrolytic capacitor are combined. In this configuration, a voltage approximately √2 times an AC input voltage is generated in the electrolytic capacitor. Therefore, it is necessary to select, for example, a component having a high withstand voltage of 400 V as the electrolytic capacitor. This electrolytic capacitor has been an obstacle to downsizing and cost reduction of the AC/DC converter.

### SUMMARY

### Overview

The present disclosure has been made in view of such a situation, and one general purpose thereof is to downsize an AC/DC converter.

One embodiment of the present disclosure relates to a rectifier circuit. The rectifier circuit includes: a bridge circuit that rectifies an AC voltage; and a voltage clamp circuit that includes a clamp transistor and a smoothing capacitor sequentially connected in series between an output terminal of the bridge circuit and a ground line and is structured to control on and off of the clamp transistor according to an output voltage of the bridge circuit. The ground line is common to a ground line of a DC/DC converter at a subsequent stage.

Note that arbitrary combinations of the above components and conversions of components and an expression between a method, an apparatus, a system, and the like are also effective as embodiments of the present disclosure. Furthermore, since the description of this item (SUMMARY OF THE INVENTION) does not describe all essential features of the present disclosure, subcombinations of these features described may also be included in the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram of an AC/DC converter according to an embodiment;

FIG. 2 is a waveform diagram for explaining the operation of the AC/DC converter of FIG. 1;

FIG. 3 is a circuit diagram of an AC/DC converter according to comparative technology;

FIG. 4 is a circuit diagram of an AC/DC converter according to an example; and

FIG. 5 is a waveform diagram for explaining the operation of the AC/DC converter of FIG. 4.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A rectifier circuit according to an embodiment includes: a bridge circuit that rectifies an AC voltage; and a voltage clamp circuit that includes a clamp transistor and a smoothing capacitor sequentially connected in series between an output terminal of the bridge circuit and a ground line, and is structured to control on and off of the clamp transistor according to an output voltage of the bridge circuit. The ground line is common to a ground line of a DC/DC converter at a subsequent stage.

According to this configuration, by clamping a voltage across the smoothing capacitor, a withstanding voltage required for the smoothing capacitor can be reduced. As a result, a small electrolytic capacitor can be used as the smoothing capacitor, and an apparatus can be reduced in size and cost. In addition, since reference voltages of the smoothing capacitor and the DC/DC converter at the subsequent stage are common (ground common), it is easy to drive and control the DC/DC converter at the subsequent stage.

In an embodiment, the DC/DC converter may have a first bootstrap circuit including a first rectifier element, a first bootstrap line, and a first bootstrap capacitor. The clamp transistor may be an N-type transistor. The voltage clamp circuit may include: a gate driver having an output node connected to a control terminal of the N-type transistor, a lower power supply node connected to the capacitor, and an upper power supply node; and a second bootstrap circuit including a second bootstrap line connected to the upper power supply node of the gate driver, a second bootstrap capacitor connected between the second bootstrap line and the capacitor, and a second rectifier element connected between the second bootstrap line and the first bootstrap line.

According to this configuration, a gate high voltage necessary for driving the clamp transistor can be generated only by adding the second bootstrap circuit without adding another power supply.

An AC/DC converter according to an embodiment may include: any one of the rectifier circuits described above; and a DC/DC converter having the ground line commonly connected in parallel with the capacitor of the rectifier circuit.

In an embodiment, the DC/DC converter may include a high-side transistor and a low-side transistor, and a non-isolated gate drive circuit that drives the high-side transistor and the low-side transistor. As described above, since the reference voltages of the smoothing capacitor of the rectifier circuit and the DC/DC converter are common (ground common), a drive circuit of a switching element of the DC/DC converter at the subsequent stage can be configured with a non-isolated simple circuit.

### Embodiments

Hereinafter, preferred embodiments will be described with reference to the drawings. The same or equivalent components, members, and processes illustrated in the drawings will be denoted by the same reference numerals, and repeated description will be omitted as appropriate. Further, the embodiments do not limit the disclosure and the invention, but are exemplary, and all features and combinations thereof described in the embodiments are not necessarily essential to the disclosure and the invention.

In the present specification, a “state where a member A is connected to a member B” includes not only a case where the member A and the member B are directly connected physically but also a case where the member A and the member B are indirectly connected via another member that does not substantially affect an electrical connection state or does not impair a function and an effect provided by connection.

Similarly, a “state where a member C is provided between the members A and B” includes not only a case where the members A and C or the members B and C are directly connected but also a case where the members A and C or the members B and C are indirectly connected via another member that does not substantially affect an electrical connection state or does not impair a function and an effect provided by connection.

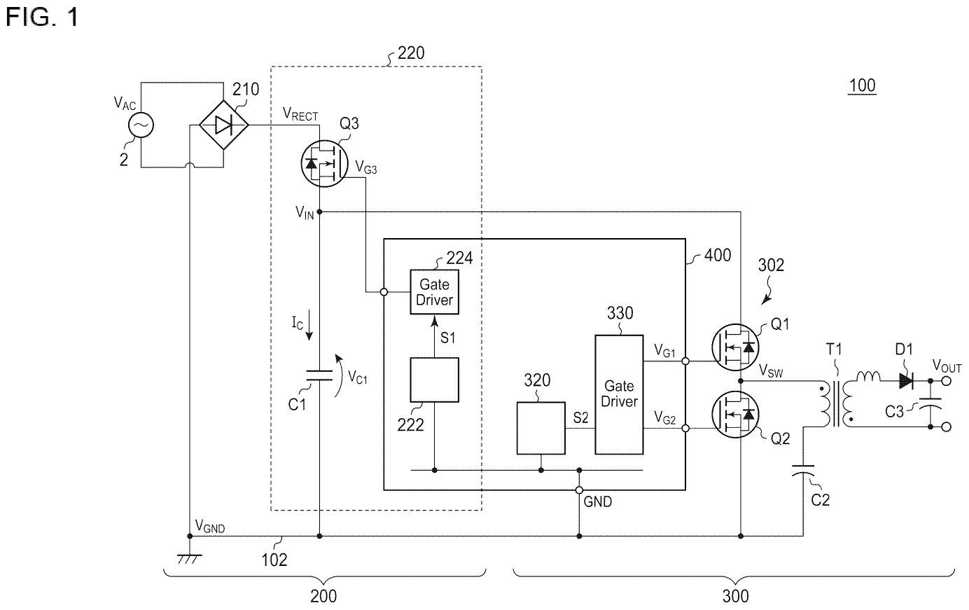

FIG. 1 is a circuit diagram of an AC/DC converter 100 according to an embodiment. The AC/DC converter 100 receives an AC voltage V_{AC} from an AC power supply 2 and converts the AC voltage V_{AC} into a DC voltage V_{OUT}.

The AC/DC converter 100 includes a rectifier circuit 200 and a DC/DC converter 300.

The rectifier circuit 200 rectifies the AC voltage V_{AC} and converts the AC voltage V_{AC} into a DC input voltage V_{IN}. The DC/DC converter 300 converts the DC input voltage V_{IN} into a DC output voltage V_{OUT}.

The rectifier circuit 200 includes a bridge circuit 210 and a voltage clamp circuit 220. The bridge circuit 210 is a diode bridge circuit, and full-wave rectifies the AC voltage V_{AC}.

The voltage clamp circuit 220 includes a clamp transistor Q3 and a smoothing capacitor C1 sequentially connected in series between an output terminal of the bridge circuit 210 and a ground line 102. The voltage clamp circuit 220 is configured to control on and off of the clamp transistor Q3 according to an output voltage (referred to as rectified voltage) V_{RECT} of the bridge circuit 210. A voltage V_{C1} generated in the smoothing capacitor C1 is supplied as the input voltage V_{IN} to the DC/DC converter 300 at a subsequent stage. That is, a switching circuit (half-bridge circuit) of the DC/DC converter 300 is connected in parallel with the smoothing capacitor C1.

The voltage clamp circuit 220 includes a controller 222 and a gate driver 224. The controller 222 generates a control signal S1 instructing on and off of the clamp transistor Q3 based on the output voltage V_{RECT} of the bridge circuit 210. A method for generating the control signal S1 by the controller 222 is not particularly limited, and the control signal S1 may be generated such that the voltage V_{C1} across the smoothing capacitor C1 does not exceed a certain threshold voltage V_{TH}.

For example, when the rectified voltage V_{RECT} exceeds the threshold voltage V_{TH}, the controller 222 changes the control signal S1 to a level corresponding to off of the clamp transistor Q3. In addition, when the rectified voltage V_{RECT} falls below the input voltage V_{IN}, the controller 222 changes the control signal S1 to a level corresponding to on of the clamp transistor Q3.

The gate driver 224 controls a gate voltage V_{G3} of the clamp transistor Q3 based on the control signal S1.

The topology of the DC/DC converter 300 is not particularly limited, and an isolated converter or a non-isolated converter can be used. For example, the DC/DC converter 300 may be an asymmetrical half-bridge (AHB) converter.

The DC/DC converter 300 includes a half-bridge circuit 310, a transformer T1, a resonance capacitor C2, a diode D1, an output capacitor C3, a controller 320, and a gate driver 330. The half-bridge circuit 310 includes a high-side transistor Q1 and a low-side transistor Q2. The controller 320 generates a control signal S2 that is a pulse signal such that the output voltage V_{OUT} approaches a target level. A method for generating the control signal S2 is not particularly limited, and pulse width modulation, pulse frequency modulation, or the like can be used. The gate driver 330 generates gate voltages V_{G1} and V_{G2} of the high-side transistor Q1 and the low-side transistor Q2 according to the control signal S2.

The controller 222, the gate driver 224, the controller 320, and the gate driver 330 may be integrated on one semiconductor substrate to form a control integrated circuit (IC) 400. The controller 222, the controller 320, and the gate driver 330 are connected to a common ground line 102 with the voltage clamp circuit 220 and operate based on a common reference voltage (ground voltage).

The configuration of the AC/DC converter 100 has been described above. Subsequently, the operation will be described.

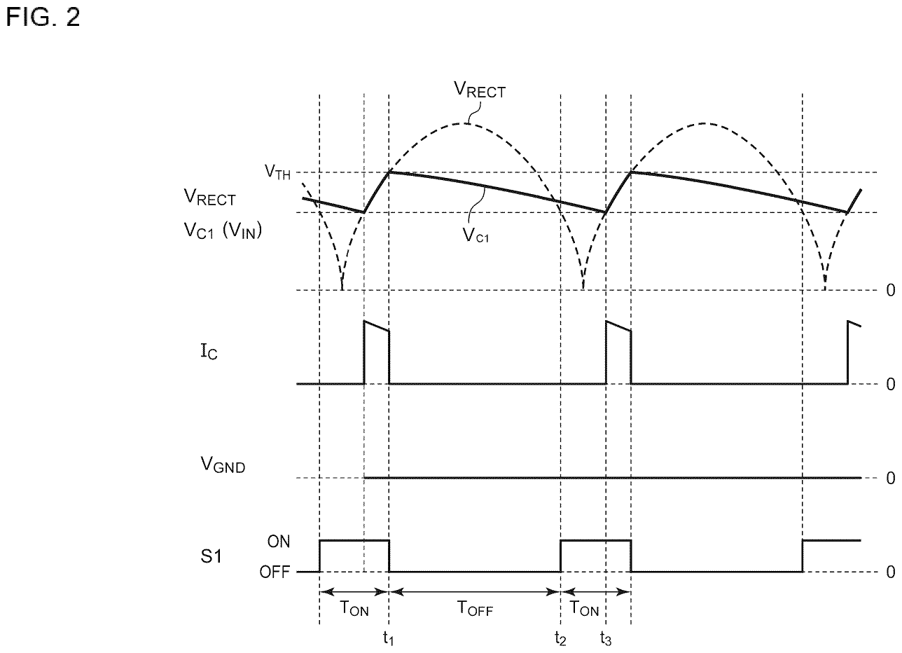

FIG. 2 is a waveform diagram for explaining the operation of the AC/DC converter 100 of FIG. 1. FIG. 2 illustrates, in order from the top, a rectified voltage V_{RECT} that is an input of the voltage clamp circuit 220, a voltage V_{C1} (input voltage V_{IN}) of the smoothing capacitor C1, a charging current I_{C} flowing through the smoothing capacitor C1, a voltage V_{GND} of the ground line 102, and a control signal S1 instructing on and off of the clamp transistor Q3.

The rectified voltage V_{RECT} is obtained by full-wave rectifying the AC voltage V_{AC} and has a waveform in which a negative portion of a sine wave is folded back to the positive side. During a period T_{ON} where the control signal S1 is high, that is, the clamp transistor Q3 is turned on, when V_{RECT}>V_{C1} is satisfied, the clamp transistor Q3 is charged, and the voltage V_{C1} of the smoothing capacitor C1 increases following the rectified voltage V_{RECT}.

Then, when the rectified voltage V_{RECT} reaches the threshold voltage V_{TH} at time t₁, the control signal S1 becomes low, and the clamp transistor Q3 is turned off. During a period T_{OFF} where the clamp transistor Q3 is turned off, the smoothing capacitor C1 is discharged by an input current of the DC/DC converter 300 and the voltage thereof decreases with time.

When the rectified voltage V_{RECT} becomes lower than the voltage V_{C1} of the smoothing capacitor C1 at time t₂, the control signal S1 becomes high, and the clamp transistor Q3 is turned on. Since V_{RECT}<V_{C1} is satisfied immediately after the clamp transistor Q3 is turned on, the smoothing capacitor C1 is not charged. When V_{RECT}>V_{C1} is satisfied at time t₃, charging of the smoothing capacitor C1 is started. The AC/DC converter 100 repeats the above operation.

Next, the advantages of the AC power supply 2 according to the embodiment will be described. The advantages of the AC/DC converter 100 will be clarified by comparison with comparative technology. Therefore, the comparative technology will be described.

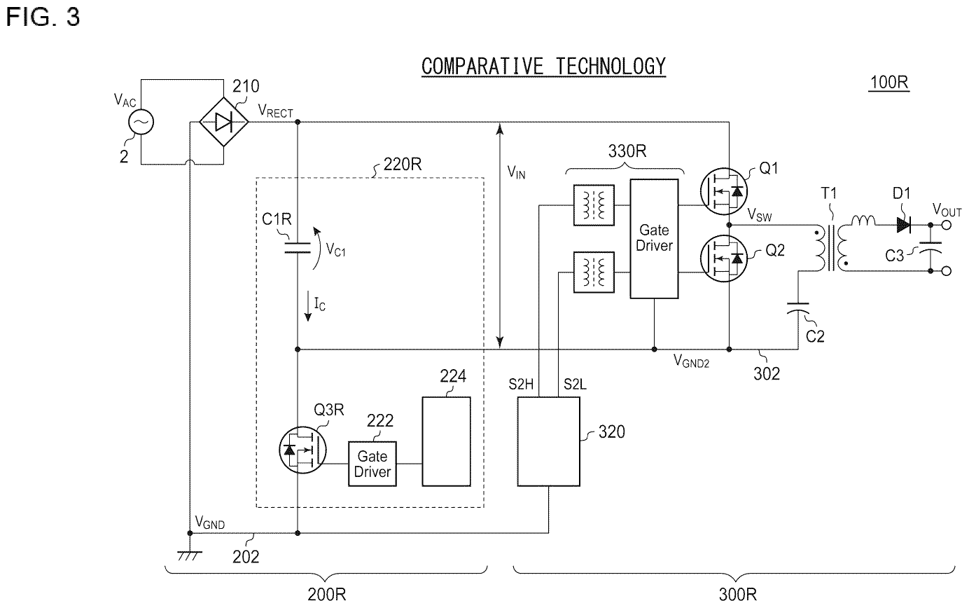

FIG. 3 is a circuit diagram of an AC/DC converter 100R according to the comparative technology. In a voltage clamp circuit 220R according to the comparative technology, positions of a smoothing capacitor CIR and a clamp transistor Q3R are switched, and the smoothing capacitor CIR is disposed on the higher potential side than the clamp transistor Q3R.

A voltage V_{C1} across the smoothing capacitor CIR is supplied as an input voltage V_{IN} to a DC/DC converter 300R at a subsequent stage. Therefore, a ground line 202 of a rectifier circuit 200R and a ground line 302 of the DC/DC converter 300R have different potentials. Furthermore, the ground line 302 of the DC/DC converter 300R is floating, and a voltage V_{GND2} thereof varies with time.

A controller 320 of the DC/DC converter 300R operates based on a ground voltage V_{GND1} on the rectifier circuit 200R side, while a gate driver 330 of the DC/DC converter 300R operates based on the floating ground voltage V_{GND2}.

In this configuration, the DC/DC converter 300R is affected by the floating ground voltage V_{GND2}. Depending on the routing (ground pattern) of the ground line 302 on a printed circuit board, there is a problem that common mode noise increases.

Furthermore, control signals S2H and S2L generated by the controller 320 cannot be directly delivered to the gate driver 330, and it is necessary to use an isolated gate drive circuit 330R, which causes a problem that the circuit is complicated and cost increases.

On the other hand, in the AC/DC converter 100 of FIG. 1, the rectifier circuit 200 and the DC/DC converter 300 are connected to the common ground line 102 and operate based on a common fixed ground voltage V_{GND} that is not floating. Therefore, in the DC/DC converter 300, the influence of the common mode noise can be reduced.

In addition, in the AC/DC converter 100 of FIG. 1, since the non-isolated gate driver 330 can be adopted, the number of circuit components can be reduced, and cost can be reduced.

The present disclosure extends to various apparatuses and methods understood as the block diagram or the circuit diagram of FIG. 1 or derived from the above description and is not limited to a specific configuration. Hereinafter, more specific configuration examples and examples will be described in order not to narrow the scope of the present disclosure but to help understanding of the present disclosure and the essence and operation of the present disclosure and to clarify them.

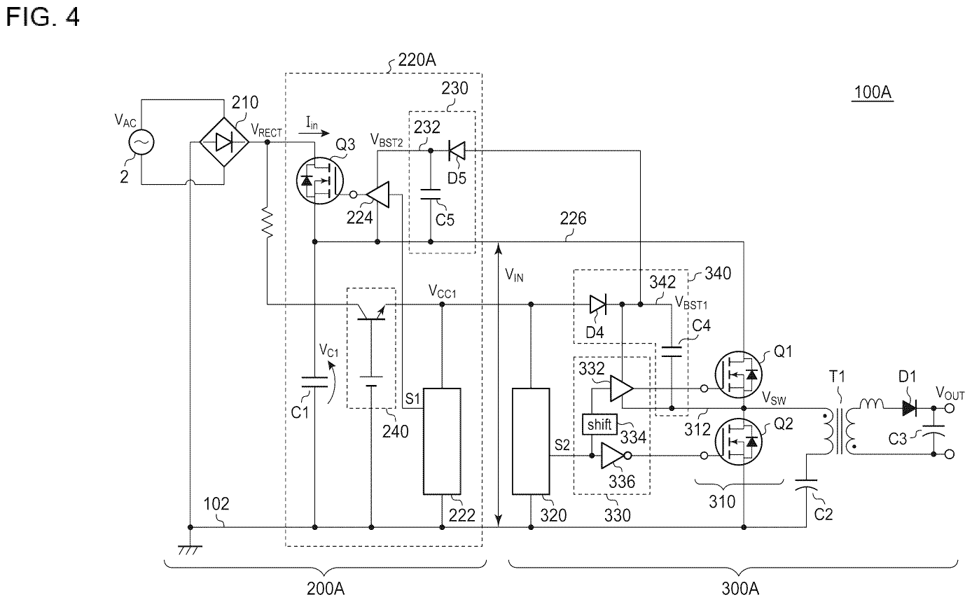

FIG. 4 is a circuit diagram of an AC/DC converter 100A according to an example. First, a DC/DC converter 300A will be described.

A high-side transistor Q1 in the DC/DC converter 300A is an N-type transistor (NMOS transistor), and the DC/DC converter 300A includes a first bootstrap circuit 340. A first bootstrap capacitor C4 is connected between a first bootstrap line 342 and a switching node 312 that is an output of the half-bridge circuit 310.

A power supply circuit 240 receives the rectified voltage V_{RECT} and generates a power supply voltage V_{CC1}. The power supply circuit 240 is a source follower power supply circuit, and includes an N-type transistor, that is, an NPN bipolar transistor or an NMOS transistor, and a constant voltage circuit 242. The power supply voltage V_{CC1} can be, for example, about 12 V.

The power supply voltage V_{CC1} is supplied to an anode of a first rectifier element D4 of the first bootstrap circuit 340, and a cathode thereof is connected to the first bootstrap line 342.

In the first bootstrap line 342, a first bootstrap voltage V_{BST1} is generated during a switching operation of the half-bridge circuit 310.

$${V}_{BST 1} = {V}_{SW} + {V}_{CC 1} - V f \qquad ( 1 )$$

V_{SW} is a switching voltage generated in the switching node 312, and Vf is a forward voltage of the first rectifier element D4.

The gate driver 330 includes a high-side driver 332, a level shifter 334, and a low-side driver 336. The first bootstrap voltage V_{BST1} is supplied to an upper power supply node of the high-side driver 332. The control signal S2 generated by the controller 320 is level-shifted up by the level shifter 334 and supplied to the high-side driver 332. The high-side driver 332 supplies a gate high voltage corresponding to the first bootstrap voltage V_{BST1} to a gate of the high-side transistor Q1 when the control signal S2 is at an on level (for example, high). As a result, a gate-source voltage of the high-side transistor Q1 becomes V_{CC1}−Vf, and the high-side transistor Q1 is turned on.

The low-side driver 336 drives the low-side transistor Q2 based on the control signal S2. The low-side driver 336 supplies a gate low voltage corresponding to the power supply voltage V_{CC1} to a gate of the low-side transistor Q2 when the control signal S2 is at an off level (for example, low). As a result, a gate-source voltage of the low-side transistor Q2 becomes V_{CC1}, and the low-side transistor Q2 is turned on.

Next, the rectifier circuit 200A will be described. Since the clamp transistor Q3 is an N-type transistor, a gate high voltage higher than the voltage V_{C1} of the smoothing capacitor C1 is required to turn on the clamp transistor Q3. In order to generate this gate high voltage, a voltage clamp circuit 220A is provided with a second bootstrap circuit 230. The second bootstrap circuit 230 generates a gate high voltage of the clamp transistor Q3 by using switching of the DC/DC converter 300A at a subsequent stage.

An output node of the gate driver 224 is connected to a control terminal (gate) of the clamp transistor Q3. A lower power supply node of the gate driver 224 is connected to an output line 226 of the voltage clamp circuit 220A.

The second bootstrap circuit 230 includes a second bootstrap line 232, a second rectifier element D5, and a second bootstrap capacitor C5. The second bootstrap line 232 is connected to an upper power supply node of the gate driver 224. The second bootstrap capacitor C5 is connected between the second bootstrap line 232 and the output line 226. A cathode of the second rectifier element D5 is connected to the second bootstrap line 232, and an anode thereof is connected to the first bootstrap line 342 of the first bootstrap circuit 340. A second bootstrap voltage V_{BST2} generated in the second bootstrap line 232 is supplied as a gate high voltage to the upper power supply node of the gate driver 224.

The configuration of the AC/DC converter 100A has been described above. Subsequently, the operation will be described.

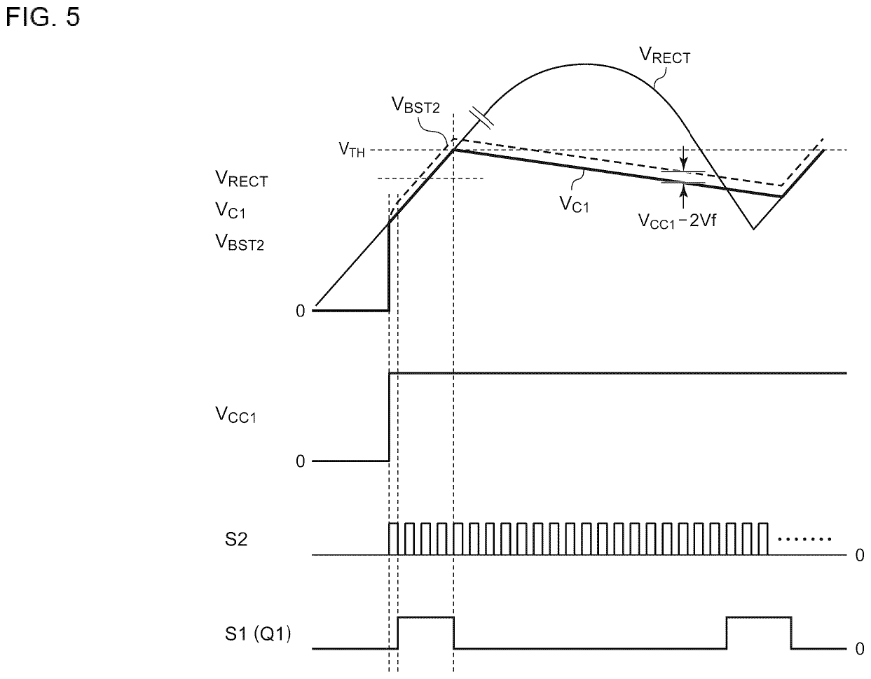

FIG. 5 is a waveform diagram for explaining the operation of the AC/DC converter 100A of FIG. 4. FIG. 5 illustrates, in order from the top, the rectified voltage V_{RECT} that is an input of the voltage clamp circuit 220, the voltage V_{C1} (input voltage V_{IN}) of the smoothing capacitor C1, the power supply voltage V_{CC1}, the control signal S2 of the DC/DC converter 300A, and the control signal S1 of the voltage clamp circuit 220A.

The first bootstrap voltage V_{BST1} is represented by Formula (1).

$${V}_{BST 1} = {V}_{SW} + {V}_{CC 1} - V f \qquad ( 1 )$$

When the high-side transistor Q1 is high, V_{SW}V_{IN} is satisfied, so that the first bootstrap voltage V_{BST1} is represented by Formula (2).

$${V}_{BST 1} = {V}_{IN} + {V}_{CC 1} - V f \qquad ( 2 )$$

When the high-side transistor Q1 is turned on, the second bootstrap capacitor C5 is charged by the first bootstrap voltage V_{BST1}. A voltage V_{C5} across the second bootstrap capacitor C5 is represented by Formula (3).

$${V}_{C 5} = {V}_{CC 1} - 2 \times V f \qquad ( 3 )$$

2×Vf is the sum of the forward voltages of the first rectifier element D4 and the second rectifier element D5.

That is, the second bootstrap voltage V_{BST2} is represented by Formula (4).

$${V}_{BST 2} = {V}_{IN} + {V}_{C 5} = {V}_{IN} + {V}_{CC 1} - 2 \times V f \qquad ( 4 )$$

When the control signal S1 is at an on level (high), the gate driver 224 supplies the second bootstrap voltage V_{BST2} as a gate high voltage to the gate of the clamp transistor Q3. A gate-source voltage V_{GS3} of the clamp transistor Q3 at this time is represented by Formula (5).

$${V}_{GS 3} = {V}_{BST 2} - {V}_{IN} = {V}_{CC 1} - 2 \times V f \qquad ( 5 )$$

As a result, the clamp transistor Q3 can be turned on.

As described above, in the rectifier circuit 200A of FIG. 4, the gate high voltage necessary for driving the clamp transistor Q3 can be generated only by adding the second bootstrap circuit 230. As a result, it is not necessary to add another power supply having a large circuit scale, and thus, it is possible to suppress an increase in the number of components and cost.

Although the embodiment according to the present disclosure has been described using specific terms, this description is merely an example for assisting understanding and does not limit the present disclosure or the claims, and the scope of the present disclosure is defined by the claims. Furthermore, not only the embodiment but also embodiments, examples, and modifications not described herein are included in the scope of the present disclosure.

### First Modification

The circuit topology of the DC/DC converter 300 is not particularly limited, and one suitable for the power and application of the AC/DC converter 100 can be selected. For example, the DC/DC converter 300 may be a flyback converter, a forward converter, or the like, or may be a full-bridge converter. In addition, the DC/DC converter 300 can use a non-isolated converter such as a step-down converter (Buck converter), a step-up converter (Boost converter), and a step-up/down converter (Buck-Boost converter) in an application that does not require insulation.

### Second Modification

In the example of FIG. 4, the technology of generating the gate high voltage of the gate driver 224 using the second bootstrap circuit 230 has been described, but the present disclosure is not limited thereto. When an increase in the number of components and cost is allowed, another power supply circuit may be added.

### Third Modification

In the embodiment, the full-wave rectifier circuit including the diode full bridge circuit has been described as the bridge circuit 210, but a half-wave rectifier circuit may be used. Instead of the diode bridge circuit, a synchronous rectification bridge circuit including four transistors may be used, or a hybrid type of a diode and a transistor may be used.

### Supplementary Note

The technology disclosed in the present specification can be understood as follows in one aspect.

### Item 1

A rectifier circuit including:
a bridge circuit structured to rectify an AC voltage; and
a voltage clamp circuit including a clamp transistor and a smoothing capacitor sequentially connected in series between an output terminal of the bridge circuit and a ground line, and structured to control on and off of the clamp transistor according to an output voltage of the bridge circuit, wherein
the ground line of the bridge circuit is common to a ground line of a DC/DC converter at a subsequent stage.

### Item 2

The rectifier circuit according to Item 1, wherein
the DC/DC converter includes a first bootstrap circuit including a first rectifier element, a first bootstrap line, and a first bootstrap capacitor,
the clamp transistor is an N-type transistor, and
the voltage clamp circuit includes:
a gate driver having an output node connected to a control terminal of the N-type transistor, a lower power supply node connected to the smoothing capacitor, and an upper power supply node; and
a second bootstrap circuit including a second bootstrap line connected to the upper power supply node of the gate driver, a second bootstrap capacitor connected between the second bootstrap line and the smoothing capacitor, and a second rectifier element connected between the second bootstrap line and the first bootstrap line.

### Item 3

An AC/DC converter including:
the rectifier circuit according to Item 1 or 2; and
a DC/DC converter having the ground line commonly connected in parallel with the smoothing capacitor of the rectifier circuit.

### Item 4

The AC/DC converter according to Item 3, wherein
the DC/DC converter includes:
a high-side transistor and a low-side transistor; and
a non-isolated gate drive circuit driving the high-side transistor and the low-side transistor.

What is claimed is:

1. A rectifier circuit comprising:
a bridge circuit structured to rectify an AC voltage; and
a voltage clamp circuit including a clamp transistor and a smoothing capacitor sequentially connected in series between an output terminal of the bridge circuit and a ground line, and structured to control on and off of the clamp transistor according to an output voltage of the bridge circuit, wherein
the ground line is common to a ground line of a DC/DC converter at a subsequent stage.

2. The rectifier circuit according to claim 1, wherein
the DC/DC converter includes a first bootstrap circuit including a first rectifier element, a first bootstrap line, and a first bootstrap capacitor,
the clamp transistor is an N-type transistor, and
the voltage clamp circuit includes
a gate driver having an output node connected to a control terminal of the N-type transistor, a lower power supply node connected to the smoothing capacitor, and an upper power supply node, and
a second bootstrap circuit including a second bootstrap line connected to the upper power supply node of the gate driver, a second bootstrap capacitor connected between the second bootstrap line and the smoothing capacitor, and a second rectifier element connected between the second bootstrap line and the first bootstrap line.

3. An AC/DC converter comprising:
the rectifier circuit according to claim 1; and
a DC/DC converter having the ground line commonly connected in parallel with the smoothing capacitor of the rectifier circuit.

4. The AC/DC converter according to claim 3, wherein
the DC/DC converter includes
a high-side transistor and a low-side transistor, and
a non-isolated gate drive circuit driving the high-side transistor and the low-side transistor.
